(19) United States
(12) Patent Application Publication
(10) Pub. No.: US 2007/0134454 A1
(43) Pub. Date: Jun. 14, 2007

(54) Perforated bag placemat

(76) Inventor: Debra Broderick, Wantagh, NY (US)

Correspondence Address: WEISS & WEISS, Suite 251, 300 Old Country Road, Mineola, NY, 11501, US

(21) Appl. No.: 11/298,325

(22) Filed: Dec. 9, 2005

(51) Int. Cl. B32B 27/10

(52) U.S. Cl. 428/34.2; 428/35.2; 428/43

(57) ABSTRACT

The present invention relates to a bag which is used to carry and store food, which can then be further used as a placemat for the meal that was carried in the bag.

### FIELD OF THE INVENTION

The present invention relates to a bag which is used to carry and store food, which can then be further used as a placemat for the meal that was carried in the bag.

### BACKGROUND OF THE INVENTION

In the past, a person went to a fast food restaurant, ordered a meal which was then served in a bag to them to be eaten at a table in the fast food establishment. Many times, the tables have been used by other patrons in the restaurant, and have not been cleared thoroughly after prior use. Especially when mothers and fathers bring their children to these food establishments, they don't want their children eating their food off of the table. Parents bring wipes to clean off the table and clean off their children's hands, but even that does not allay the concerns of the parents when their children eat off of these tables.

### SUMMARY OF THE INVENTION

The present invention relates to a bag used in food establishments so that when a user purchases their food items they are placed in the bag and the user can take the food to a table where they can eat their food. Once the food is taken out of the bag, the bag has perforations or other means for creating a placemat out of the bag so that the food that was in the bag can be placed on the placemat and not on the table.

It is an object of the present invention for the bag to be made out of paper.

It is an object of the present invention for the bag to be made out of plastic.

It is an object of the present invention for the bag to be made out of any material that is currently used by food establishments to package food once it is ordered by the user so that the user can take the food to their table or to their car.

It is an object of the present invention for the bag to have pre-cut lines in the material so that the user can tear along the lines and create the placemat.

It is an object of the present invention to have advertising within the placemat once it is torn away from the bag.

It is an object of the present invention for games to be displayed on the placemat once it is torn away from the bag.

It is an object of the present invention for the part of the bag that turns into the placemat to be made of an absorbent material so that the material can absorb any grease or any liquids that are spilled on it.

It is an object of the present invention for the placemat to be in the shape of a square.

It is an object of the present invention for the placemat to be in the shape of a circle.

It is an object of the present invention for the placemat to be in the shape of a character.

It is an object of the present invention for the placemat to have an adhesive at each end of the placemat so that it can be attached to a table, to a car seat, or to another object.

### BRIEF DESCRIPTION OF THE DRAWINGS

FIG. 1 illustrates a bag for holding food which has precut lines in it.

FIG. 2 shows the placemat after it has been torn away from the bag.

FIGS. 3 and 4 show different shapes of the placemat.

FIG. 5 shows the placemat having adhesives attached at opposite ends.

### DETAILED DESCRIPTION OF THE DRAWINGS

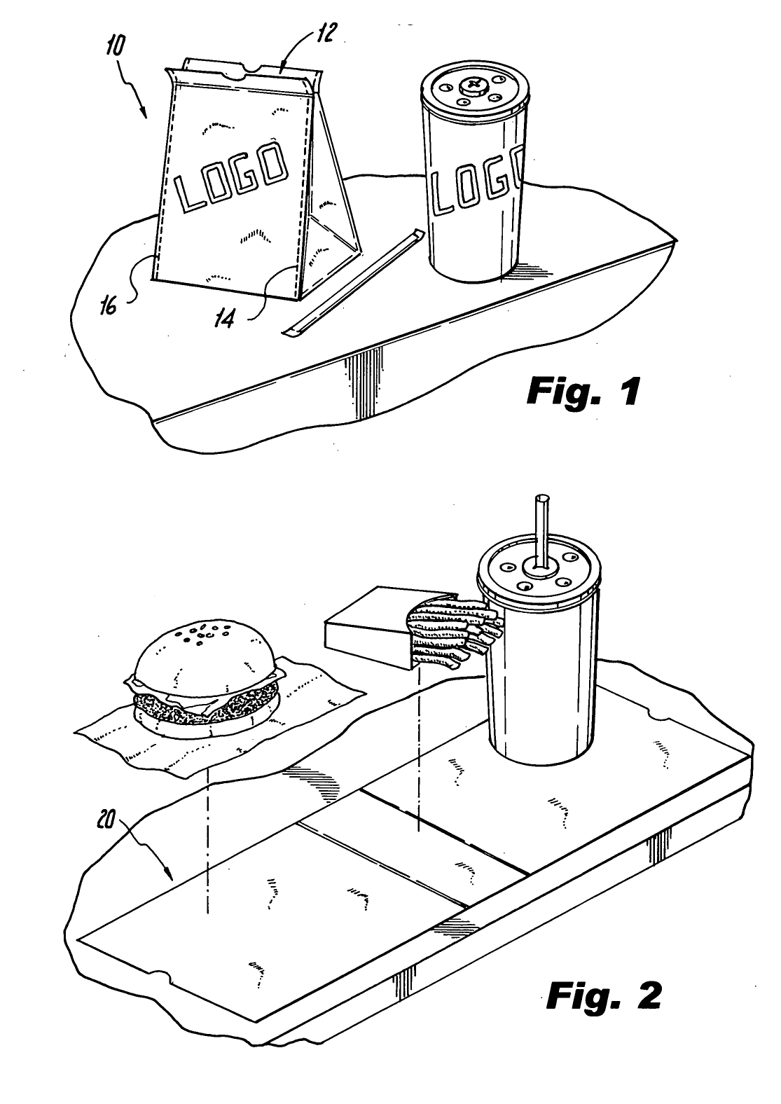

FIG. 1 shows a bag 10 which can be used to carry food. The bag 10 has an opening 12 where the food is placed in. The bag 10 has perforations 14 and 16 on each side. When the perforations 14 and 16 are torn away, a placemat is formed. The perforations 14 and 16 are at the side of the bag 10. In a preferred embodiment, the perforations are placed in the crease of the bag. When the perforations 14 and 16 are torn, the bag opens up at can be laid flat as a placemat as shown in FIG. 2.

FIG. 2 shows the placemat which represents the bag torn down the middle of the sides and opened up fully into a full size placemat 20.

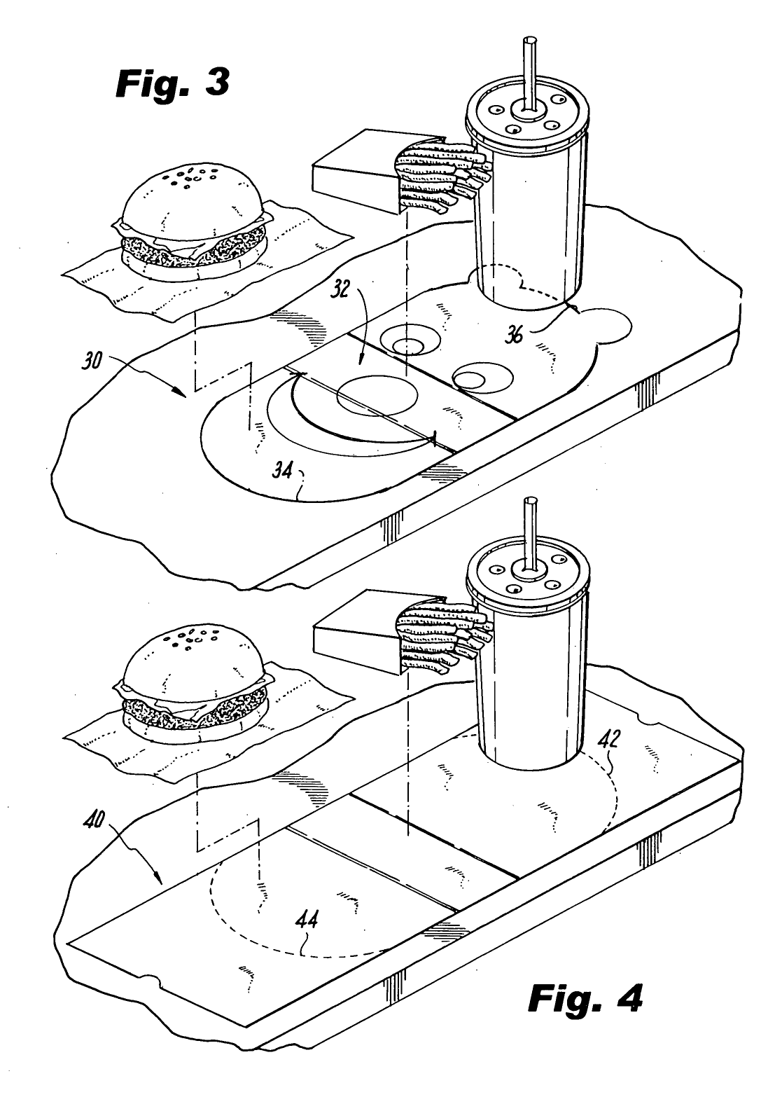

FIG. 3 shows the placemat 30 having a FIG. 32 shown on the placemat. Further perforations 34 and 36 allow a character 32 to appear in the placemat.

FIG. 4 shows the placemat 40 having perforations 42 and 44 which create a placemat 40 in the form of a circle.

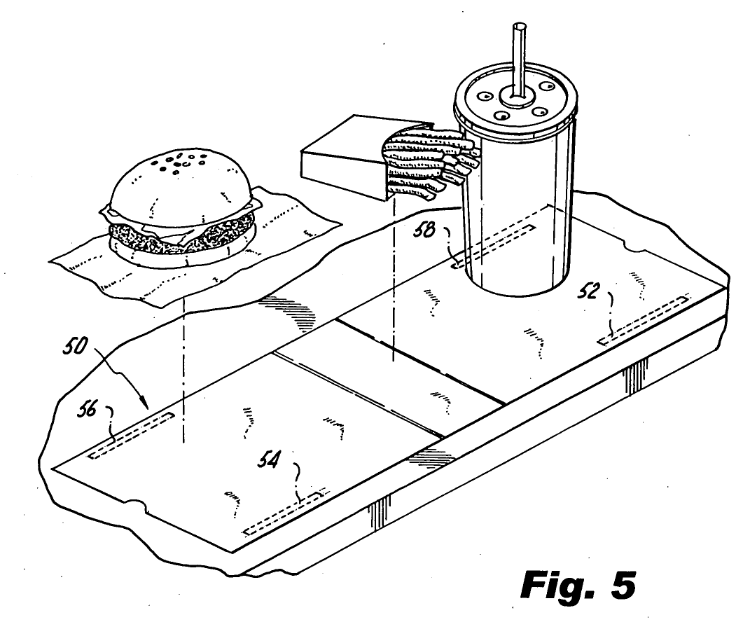

FIG. 5 shows the placemat 50 having adhesive strips 52, 54, 56 and 58 which can then be used to attach the placemat to a table or other object so that the placemat does not move.

1. A bag that can be made into a placemat comprising:
a bag;
said bag having perforations in it;
wherein when said perforations are torn from said bag said bag opens up into a placemat.

2. The bag of claim 1 wherein said bag is made of paper.

3. The bag of claim 1 wherein said bag is made of plastic.

4. The bag of claim 1 wherein said bag has advertising placed within said perforations so that it is shown to the user once the placemat is formed.

5. The bag of claim 1 wherein said bag has a game displayed within said perforations so that said game is displayed to said user once said placemat is formed.

6. The bag of claim 1 wherein said bag comprises an absorbent material.

7. The bag of claim 1 wherein said placemat is in the shape of a square.

8. The bag of claim 1 wherein said placemat is in the shape of a circle.

9. The bag of claim 1 wherein said placemat is in the shape of a character.

10. The bag of claim 1 further comprising an adhesive attached at each end of said placemat.

11. The bag of claim 10 wherein said adhesive can be attached to a table or a car seat.
